(19) United States
(12) Patent Application Publication
(10) Pub. No.: US 2005/0111705 A1
(43) Pub. Date: May 26, 2005

(54) Passive stereo sensing for 3D facial shape biometrics

(76) Inventors: Roman Waupotitsch, Santa Fe, NM (US); Gerard Medioni, Los Angeles, CA (US); Arthur Zwern, San Jose, CA (US); Igor Maslov, Mountain View, CA (US)

Correspondence Address: FISH & RICHARDSON, PC, 12390 EL CAMINO REAL, SAN DIEGO, CA, 92130-2081, US

(21) Appl. No.: 10/926,788

(22) Filed: Aug. 25, 2004

Related U.S. Application Data
(60) Provisional application No. 60/498,092, filed on Aug. 26, 2003.

(51) Int. Cl. G06K 9/00

(52) U.S. Cl. 382/118; 382/154

(57) ABSTRACT

A face recognition device which operates in sunlit conditions such as in sunlight, or in indirect sunlight. The device operates without projection of light or other illumination to the face. Stereo information indicative of the face shape is obtained, and used to construct a 3D model. That model is compared to other models of known faces, and used to verify identity based on the comparison.

### CROSS-REFERENCE TO RELATED APPLICATION

This application claims benefit of the priority of U.S. Provisional Application Ser. No. 60/498,092 filed Aug. 26, 2003 and entitled “Passive Stereo Sensing for 3D Facial Shape Biometrics.”

### BACKGROUND

Automated facial recognition may be used in many different applications, including surveillance, access control, and identity management infrastructures. Such a system may also be used in continuous identity monitoring at computer workstations and crew stations for applications ranging from financial transaction authentication to cryptography to weapons station control. Performance of certain systems of this type may be limited.

Typical techniques to acquire facial shape rely on active projection and triangulation of structured light. Time of flight systems such as LADAR or other alternatives have also been postulated.

In structured light triangulation systems, a series of patterns or stripes are projected onto a face from a projector whose separation from a sensing camera is calibrated. The projector itself may be a scanned laser point, line, or pattern, or a white light structured by various means such as a patterned reticule at an image plane, or a colored light pattern. The stripes reflect from the face back to the sensing camera. The original pattern is distorted in a way that is mathematically related to the facial shape. The 3D shape that reflected the pattern may be determined by extracting texture features of this reflected pattern and applying triangulation algorithms.

The inventors of the present system have recognized that it is difficult to use such a system under real life lighting conditions, such as in sunlight. Extraction of features requires that contrast be available between the bright and dark areas of the reflection of the projected pattern. For example: the edges of stripes must be found, or dark dots must be found in a bright field, or bright dots must be found in a dark field, etc. To achieve this contrast, the regions of the face lit by the bright areas of the pattern (“bright areas”) must be significantly brighter than the regions of the face that are unlit by the pattern (“dark areas”), by an amount sufficient to provide good signal to noise ratio at the imaging sensor.

Because the sun is extremely bright, even the “dark” areas of the projected pattern are brightly lit. Thus, the amount of irradiance required from the projector to light the “bright” areas above the dark areas becomes very large. The required brightness in the visible band would be quite uncomfortable to the subject's eyes. If done in a non-visible band such as infrared, the user may not experience eye discomfort. However, engineering a projector system this bright would be impractical at short range; and impossible or very difficult to scale to longer ranges. Too much intensity, moreover, could potentially burn the user's skin or cornea.

In summary, because achieving contrast between bright and dark areas of a reflected pattern is challenging in bright sunlight. Therefore, active projection methods have had drawbacks under outdoor conditions.

Under many actual conditions, the challenge for active methods becomes even greater than described above if the face is not evenly lit by the ambient illumination.

Previous applications assigned to Geometrix have described techniques of facial-information determination, referred to herein as “passive”, which operates without projecting patterns onto a face.

### SUMMARY

The present system describes a passive system, that is one that is capable of biometric identity verification based on sensing and comparing 3D shapes of human faces without projection of patterns onto the face in outdoor lighting conditions, e.g., either outdoors, or in bright lighting such as through a window.

This passive acquisition of biometric shape offers particular advantages. For one, shape may be acquired over a broader envelope of ambient illumination conditions than is possible using active methods. The capability of outdoor use allows use in locations such as outdoor border crossings and military base entry points.

According to one aspect, passive system for acquiring facial shape is disclosed that can operate without any additional projection of light. The system can work for very bright ambient light, limited only by the light gathering capability of the camera. The same system can also operate in low ambient light by simply illuminating the face or the entire scene using any light source, not particular to the acquisition system.

The disclosed system can capture faces under conditions of extreme lighting differences across the face.

One aspect allows identifying the face to be captured and use the information on the face position to optimize the camera settings for optimum capture of the face, before capturing the images. Another aspect describes subdividing the face into regions, so that the camera settings can be optimized to optimize reconstruction on the largest possible area of the face.

Eyeglasses and other reflective objects may be identified, to exclude the regions of the eyeglasses from the optimization of the exposure for the remaining portion of the face.

The settings of two cameras used to obtain stereo images may also be balanced, e.g. in a calibration step.

The present system has enabled determination of high quality 3D reconstruction of faces even in direct sunlight.

### BRIEF DESCRIPTION OF THE DRAWINGS

These and other aspects will now be described in detail with respect to the accompanying drawings, in which:

FIG. 1 shows a block diagram of a system; and

FIG. 2 shows a flowchart of operation.

### DETAILED DESCRIPTION

Passive facial recognition typically relies only on ambient or applied lighting to acquire image information used for the facial recognition. This is differentiated from “active” methods that project some form of probe light illumination and then assess perturbations in the reflected return to determine facial feature information.

This system described here may directly sense 3D shapes, using the techniques disclosed in U.S. Application, publication No. 20020024516. It may also compare the acquired 3D facial shapes with prestored shapes in a database. Our earlier patent application entitled “Imaging of Biometric information based on three-dimensional shapes” (U.S. patent application Ser. No. 10/430,354) describes such a system for automated biometric recognition that matches 3D shapes. Many aspects of shape are true invariants of an individual that can be measured independent of pose, illumination, camera, and other non-identity contributors to facial images.

In an aspect, passive methods may be used to detect the presence and location of a face within an acquired scene that was acquired under sun-lit conditions such as in or near daylight. The control module automatically optimizes camera settings. The optimized parameters may include exposure speed and color balance, to optimize contrast of naturally occurring features on the facial surface. One embodiment operates by obtaining an image, and identifying a face within the image. Camera settings are automatically optimized to try to obtain the best image information regarding the face. This can simply use exposure/picture modifying software which is the same as that used within a consumer camera, with the point of ‘focus’, being the face. The camera settings are then automatically optimized to obtain information about the region including the face. Another technique may use specified exposure settings to determine the amount of information that is obtained at each exposure setting, followed by setting the exposure to the optimum exposure setting to obtain information for the specified lighting and face combination.

In one aspect, the system may subdivide the face into regions, e.g. quadrants. Camera settings may be separately adjusted for each region or the camera settings may be set so that the image quality over all the regions, e.g. quadrants, is optimized. This may allow both bright areas and dark areas to be captured with sufficient contrast to acquire 3D shape.

An active method which projects stripes may not do this well or efficiently, because all stripes are the same brightness. Therefore, a bright stripe may project onto a part of the face that is already brightly lit by ambient illumination or onto a dark area that is shadowed. The ability to adjust exposure conditions and retrospectively adjust the image after its acquisition may produce additional advantages, and may enable acquiring of three dimensional shape over a larger region of the face compared to active methods, under many real-world ambient conditions.

This system also describes removing artifacts from highly reflective objects. For example, eyeglasses can be detected within a subject, and either removed from the image or ignored for purposes of adjusting camera settings such as exposure. In an active projection method, the presence of highly reflective and/or highly specular reflections due to metallic and glass components causes further complications. This may also create artifacts, such as spurious depth results, ghosting, and even complete saturation of the sensed image due to a direct high intensity reflection back into the sensing camera.

Structured light methods fail to offer covertness, as the projected light pattern is easily detectable. In contrast, passive methods utilize ambient light. This can be done covertly, unlike active methods, that require illumination, and that illumination can be seen. In very dark conditions, any lighting system, not necessarily particular to the illumination system, may be used to illuminate the face (and body) without communicating the presence of a facial sensor.

After obtaining the 3D information, the images may be formed into depth maps, and then used to compare against templates of known identities to determine if the current 3D information matches any of the 3D information of known identities. This is done, for example, using the techniques described in 10/430,354, to extract positions of known points in the 3D mesh. This system may alternately be used to create 2D information from the acquired 3D model, using techniques disclosed in “Face Recognition based on obtaining two dimensional information from three dimensional face shapes”; application Ser. No. 10/434,481, the disclosure of which is herein incorporated by reference. Briefly, the three-dimensional system disclosed herein may be used to create two-dimensional information for use with other existing systems.

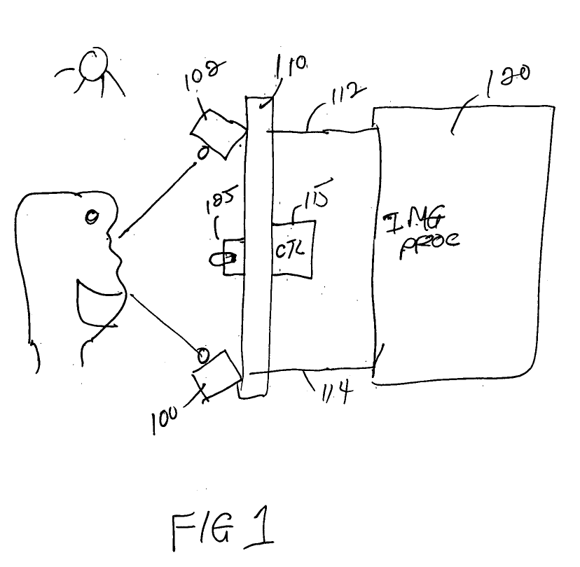

An embodiment for obtaining the face information is shown in FIG. 1. Two closely spaced and synchronized cameras are used to simultaneously acquire images. The two cameras 102 and 100 may be board mounted cameras, mounted on a board 110, or may simply be at known locations. While two “stereo” cameras are preferred for obtaining this information, alternative passive methods for shape extraction, including alternative stereo implementations, and single-camera “synthetic stereo” methods that simulate stereo using a single video camera and natural head motion may be used. This is described in our prior application entitled “3D Model from a Single Camera” (U.S. patent application Ser. No. 10/236,020).

A camera control system 115, which may be common for the two cameras, controls the cameras to allow them to receive the information simultaneously, or close to simultaneously.

The outputs of the two cameras 112, 114 are input to an image processing module 120 which correlates the different areas of the face to one another. The image processing 120 may be successful so long as there is sufficient contrast in the image to enable the correlation. The system as shown in FIG. 1 is intended to be used outdoors, and to operate based on the ambient light only. However, the image processing module and/or control module 115 may determine nighttime conditions, that is when the ambient light is less than a certain amount. When this happens, an auxiliary lighting device shown as 125 may project plain light (that is, not patterned light) for the facial recognition.

The basic concept is shown in FIG. 1; A passive camera pair 100, 102 is used to acquire an image of a scene 104 from slightly different angles. The passive camera acquires dual images shown as 104, 106. These dual images are combined by correlating the different parts with one another in an image processing module 120. The module may operate as described in our co-pending application, or as described in 20020024516, the contents of which are each herein incorporated by reference. Briefly stated, however, this operates by obtaining two images of the same face from slightly different points, aligning the images, forming a disparity surfaces between the images, and forming a 3 dimensional surface from the information.

This creates a 3-D shape which is invariant with respect to pose and illumination. The 3-D shapes vary only as a function of temporal changes that are made by the individuals such as facial hair, eyewear, and facial expressions.

The 3D shape may not be complete, based on lack of sufficient lighting or contrast. Since the matching is based on extraction of a variety of features spread almost uniformly over the 3D shape, this system can still operate properly even when only a partial model is formed from the available information. For example, the lighting and contrast may be such that only parts of the face are properly imaged. This may lead to only a partial model of the face being formed. However, even that partial model may be sufficient to match the face against the information in the database, to determine matching. Control and extraction device 115 may control and synchronize the cameras. The dual camera system may be formed simply of a pair of consumer digital cameras on a bracket. In the embodiment, 3.2 megapixel cameras, capturing 2048 by 1536 pixels (the Olympus C-3040) are used in one embodiment. Another embodiment describes board mounted cameras, from Lumenera Corporation, the LC200C. Different parameters within which the passive acquisition can properly operate may be determined and used to automatically set in the cameras.

The Lumenera model LU200C cameras delivers 2 Mpixel image pairs via a USB2.0 interface. Image pairs are received by the host CPU within a fraction of a second after acquisition. This allows a preview mode, wherein the subject or an operator can view the subject's digital facial imagery in near-real-time to ensure that the face is fully-contained within the image, or to use a face-finding algorithm to automatically select the optimal pair of images for 3D processing from a continuous image stream.

The total cycle for the probe includes the following parts: 1) triggering (telling the system to acquire), 2) acquisition (sensing the raw data, in this case an image pair), 3) data transfer (sending the image data from camera to CPU and others), 4) biometric template extraction time (extracting a 3D facial model from the stereo image pair, and then processing it into a template), and 5) matching (recognition engine processing to yield yes/no). It is desirable to minimize the total time. 3D model extraction time may take the longest time and actions may be taken to reduce this time.

While the present application describes specific ways of obtaining the 3D shape and comparing it to template shapes, it should be understood that other techniques of modeling and/or matching can be used.

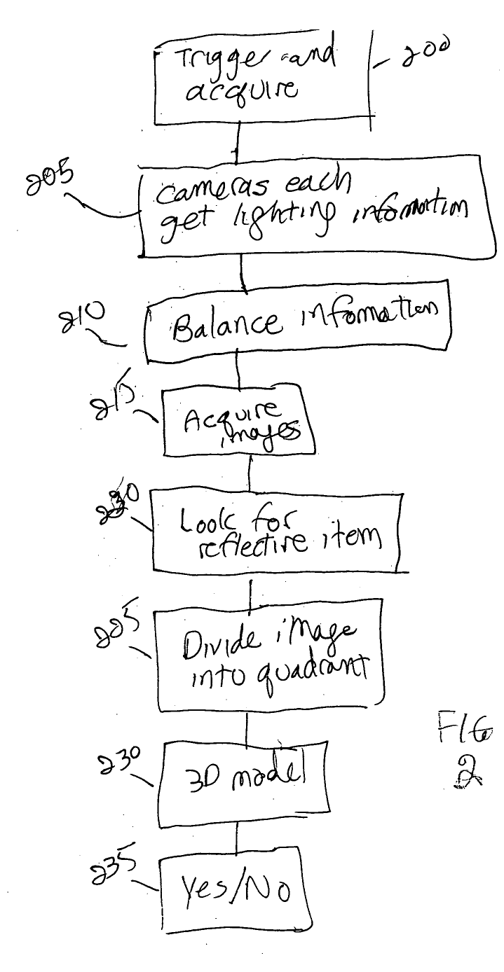

The specific processing may be carried out as shown in the flowchart of FIG. 2. The process starts with the trigger and acquire which occurs at 200, in which the system detects an event that indicates that a face is to be seen, and triggers the cameras to operate. In response to the trigger acquire, the cameras each take either a full picture, or a piece of a picture with sufficient information to assess the camera parameters that should be used. Alternatively, at this point the face is found in the images and the knowledge of the location of the face within the images is used to optimize the camera parameters in 205 for optimum capture of the face region. Alternatively, this may use automatic camera adjustment techniques such as used on conventional consumer electronic cameras. Each camera therefore gets its optimum value at 205.

At 210, the values are balanced by a controller, so that the two cameras have similar enough characteristics to allow them to obtain the same kind of information.

At 215, the images are acquired by the two cameras in sun-lit conditions.

220 processes those image to look for reflective items, such as glasses, within those images, and to mask out any portions or artifacts of the images related to those reflective items. This can be done, for example, by looking for an item which has a brightness that is much greater than other brightnesses within the image.

225 divides the image into quadrants, and adjusts the contrast of each quadrant separately. The raw data output from 225 is used to form a three-dimensional model at 230, using any of the techniques described above. This three-dimensional model is then used to establish a yes or no match, relative to a stored three-dimensional model at 235.

Camera adjustments can be done to maintain the proper parameters for acquiring and analyzing the images and 3d information.

Dynamic range is adjusted to perform a high quality reconstruction. This gives a baseline for the lighting requirements; it also gives a measure to predict 3D model quality from the dynamic range of the image, and in consequence to predict the quality from the available light. An automatic dynamic range adjustment may maximize the amount of the face that can be acquired.

Focus range. Describes the precision in positioning the subject along a direction towards/away from the camera.

Exposure control. The envelope of different exposure settings usable at one illumination level describes the requirements for automated exposure/gain control in a deployable system.

Adjustment of gain-setting of the camera may improve results.

An exposure control loop capable of real-time operation may be used, to adjust as a human walks through an unevenly lit, covert probe location.

To summarize the experiments that were carried out, under all indoor lighting conditions evaluated, sufficiently high model quality can be achieved to perform recognition when using the integrated lighting and when camera exposure adjustment is allowed. For most scenarios, acceptable results can be achieved without any camera exposure adjustment.

Most importantly it is seen that in some office environments that are subjectively considered as “typical”, the system may be used without system lighting, relying only upon ambient.

1. A method comprising:
acquiring image information about a subject's face under sunlit conditions;
using said image information to produce a three-dimensional model indicative of the subject's face; and
using said three-dimensional model to recognize an identity of said subject's face.

2. A method as in claim 1, wherein said sunlight conditions include indirect sunlight.

3. A method as in claim 1, wherein said using said image information to create a three-dimensional model comprises changing settings used to obtain the image, to adjust contrast of the image.

4. A method as in claim 3, wherein said processing the image comprises adjusting one part of the image separately from another part of the image.

5. A method as in claim 3, wherein said processing the image comprises processing quadrants of the image separately.

6. A method as in claim 3, wherein said processing the image comprises finding areas of increased reflectivity within the image.

7. A method as in claim 1, wherein said acquiring comprises automatically adjusting a device which acquires the image.

8. A method as in claim 1, wherein said acquiring comprises obtaining two separate images from two separate vantage points, and separately adjusting devices obtaining said two separate images.

9. A method as in claim 8, further comprising as synchronizing said devices that obtain said images.

10. A method as in claim 1, wherein said acquiring image information acquires the information without any projection of light.

11. A system, comprising:
an image acquisition device, which obtains image information in sunlit conditions, from which a three-dimensional model of a face can be obtained;
a processor, which combines said three-dimensional information to form a three-dimensional model of the face;
and compares said three-dimensional model to other three-dimensional models indicative of other faces.

12. A system as in claim 11, wherein said image acquisition device includes a settings adjustment part that automatically adjusts settings of obtaining the image, to acquire said image information in indirect sunlight.

13. A system as in claim 11, wherein said image acquisition device is operated with settings to acquire said image information in indirect sunlight.

14. A system as in claim 11, wherein said image acquisition device is operated with settings to acquire said image information in direct sunlight.

15. A system as in claim 11, further comprising an image acquisition device adjusting unit, which adjusts characteristics of acquisition of said image device, depending on exposure conditions.

16. A system as in claim 11, wherein said processor also operates to find regions of increased reflectivity in the image information, and to remove said regions prior to forming said three-dimensional model.

17. A method comprising:
first, adjusting settings of an image acquiring device, according to current sunlit lighting conditions, by determining image information about a subject's face under said current sunlit conditions, and adjusting said settings based on said image information;
after said adjusting, using said image acquiring device to acquire images of the subject's face;
using said images to produce a three-dimensional model indicative of the subject's face; and
using said three-dimensional model to recognize an identity associated with said subject's face.

18. A method as in claim 17, wherein said sunlight conditions include indirect sunlight.

19. A method as in claim 17, wherein said sunlight conditions include direct sunlight.

20. A method as in claim 17, wherein said sunlight conditions include sunlight coming in via a window.

21. A method as in claim 17, further comprising processing the image to adjust one part of the image separately from another part of the image.

22. A method as in claim 17, further comprising processing the image comprises to find areas of increased reflectivity within the image.

23. A method as in claim 3, wherein said processing the image comprises adjusting the image based on knowledge of and using the information of the position of the face in the image.
